(19) United States
(12) Patent Application Publication
(10) Pub. No.: US 2015/0142693 A1
(43) Pub. Date: May 21, 2015

(54) PRESSURE ACTIVATION MAT AND METHOD FOR SELLING FOOTWEAR

(71) Applicant: Deckers Outdoor Corporation, Goleta, CA (US)

(72) Inventors: Michael Ryan Minter, Rancho Santa Margarita, CA (US); Tom Garcia, Santa Barbara, CA (US)

(73) Assignee: Deckers Outdoor Corporation, Goleta, CA (US)

(21) Appl. No.: 14/084,849

(22) Filed: Nov. 20, 2013

(51) Int. Cl. G06Q 30/02; G08B 5/36; G08B 3/10

(52) U.S. Cl. CPC G06Q 30/0281; G08B 3/10; G08B 5/36
USPC 705/346

(57) ABSTRACT

An apparatus for marketing and selling footwear, the footwear having a footbed, comprises a mat having one or more layers, the top layer of the mat comprising the same material as footwear footbed, e.g., yoga mat foam. At least a portion of an upper of one of more units of the footwear, preferably a plurality of different size upper portions, is/are attached to the mat. At least one sensor is coupled to the mat and configured to sense a consumer's foot on the mat, and in response an output device emits a sound expressing happiness in the comfortable sensation of the user's foot on the mat. Thereby, the consumer's buying experience is enhanced.

### FIELD OF THE INVENTION

This disclosure relates to apparatus and methods for selling footwear, and more specifically to mats comprised of footbed foam.

### BACKGROUND OF THE INVENTION

In a retail setting consumers buying footwear will customarily try on a pair of sandals, shoes or boots to gauge fit, comfort and style. However, trying on shoes typically requires the assistance of a sales person. With respect to comfort category footwear, getting consumers to try on a pair is a key factor in successful marketing. The consumer's sensation of comfort can drive sales.

In other settings, e.g., self-service retail or online retail, consumers do not is have an opportunity to try on a pair in advance of sale. Accordingly, the opportunity to sell the consumer on comfort is lacking.

### SUMMARY OF THE INVENTION

A basic embodiment of the invention is an apparatus for marketing and selling footwear, the footwear having a sole having one or more sole layers and an upper.

The apparatus comprises a mat having one or more layers, at least a portion of the top layer of the mat being comprised of the same material as the top layer of the footwear sole. At least a portion of an upper of at least one unit of the footwear, more preferably a plurality of upper portions, is/are attached to the mat over the portion of the top layer of the mat that is comprised of the same material as the top layer of the footwear sole. At least one sensor is coupled to the mat and configured to sense a consumer's foot on the mat. An audio or visual output device is operatively connected to the sensor and is configured to output an audio or visual signal in response to a consumer's foot on the mat. For example, the output may be as sound expressing happiness in the comfortable sensation of the user's foot on the mat. Thereby, the consumer's buying experience is enhanced by the sensation of her or his foot on the mat made of the same material as the footwear footbed, and hearing a corresponding sound or image. The mat with sound effects becomes an attraction in a retail setting, thereby encouraging consumers to try it. The resulting comfort felt by the consumer as reinforced by the happy sound can motivate purchase and drive sales.

One embodiment of a method of selling footwear having a sole and an upper, comprises providing a mat having one or more layers, at least a portion of a top layer of the mat comprised of the same material as a top layer of the footwear sole; sensing a consumer's foot on the mat; and generating a happy sound in response to a consumer's foot on the mat.

Another embodiment of a method of selling footwear having a sole and an upper comprises providing a mat comprised of the same material as the footwear sole, at least a portion of an upper of a plurality of units of the footwear attached to the mat, and at least one sensor for sensing the location of a consumer's foot on the mat; and connecting the sensor to at least one of a sound generator, a vending machine and a computer. When a consumer's foot is sensed on the mat, the a signal is generated in response to a consumer's foot on the mat, and is communicated to the sound generator, vending machine or computer. The signal may merely signify the presence of a consumer's foot on the mat, and/or may signify a size determination, and/or may signify a consumer choice, for example, a particular style or color.

The foregoing and other aspects and features of the disclosure will become apparent to those of reasonable skill in the art from the following detailed description, as considered in conjunction with the accompanying drawings.

### BRIEF DESCRIPTION OF THE DRAWINGS

FIG. 1 is a plan view of one embodiment of an apparatus of the invention.

FIG. 2 is an elevational view of one end of he apparatus of FIG. 1.

FIG. 3 is a perspective view of a unit of footwear.

FIG. 4 is an electrical diagram.

FIG. 5 is a schematic diagram of one footwear marketing embodiment of the invention.

FIG. 6 is a schematic diagram of a further footwear marketing embodiment of the invention.

FIG. 7 is a schematic diagram of another footwear marketing embodiment of the invention.

FIG. 8 is a schematic diagram of yet another footwear marketing embodiment of the invention.

FIG. 9 is a schematic diagram of a making method of the invention.

FIG. 10 is a schematic diagram of another marketing method of the invention.

FIG. 11 is a schematic diagram of yet another marketing method of the invention.

### DETAILED DESCRIPTION OF THE PREFERRED EMBODIMENTS

Preferred embodiments of the present disclosure are described below by way of example only, with reference to the accompanying drawings.

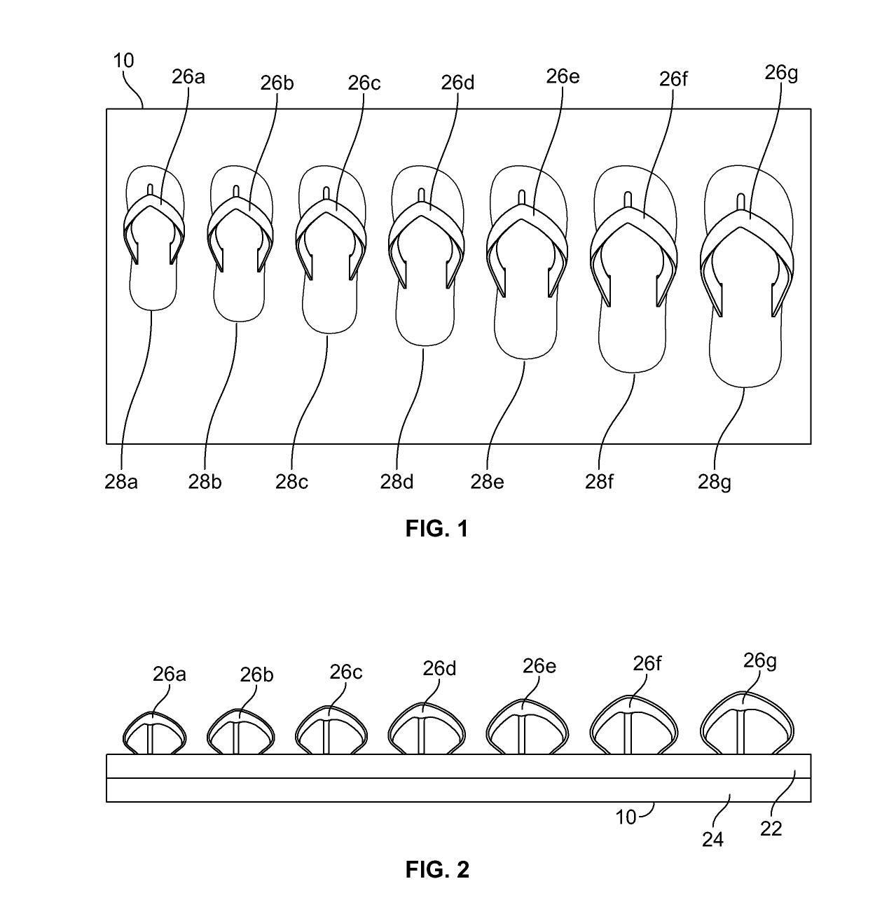

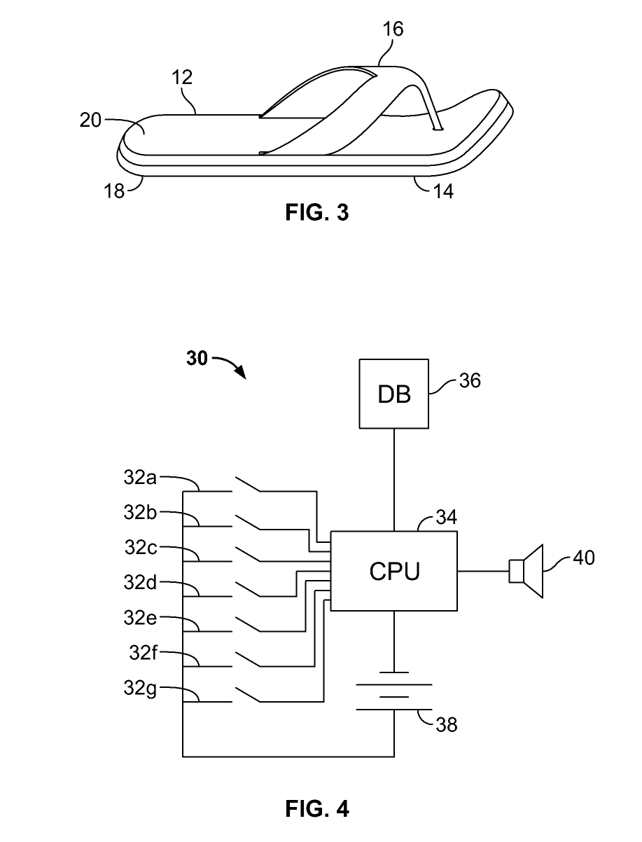

FIGS. 1 and 2 show an exemplary view of footwear mat 10 in accordance with one embodiment of the invention. As described herein, the mat 10 is used to market footwear. One embodiment of a unit of footwear 12, namely a sandal, is shown in FIG. 3. is The sandal 12 comprises a sole 14 and an upper 16. The sole may comprise one or multiple layers, e.g., an outsole 18 and a footbed 20. A separate midsole may be provided or the midsole may be combined with the footbed as shown in FIG. 3. The outsole may be formed of any conventional material, preferably a material that provides traction and wear resistance. The footbed is comprised of a natural or synthetic foam material, such as polyvinyl chloride, ethyl vinyl acetate, or closed foam natural rubber. In a preferred embodiment the footbed is formed of yoga mat foam, which provides excellent cushioning and grip between the consumer's foot and footbed. The upper 16 may be of any configuration, including sandal, shoe and mule configurations. A flip-flop sandal upper is shown in the FIG. 3 embodiment. A preferred footwear embodiment is the Sanuk® Yoga Mat sandal, available at www.sanuk.com.

The mat 10 may comprise a single layer, or more preferably two or more layers. In the FIGS. 1-2 embodiment, the mat comprises a top layer 22 and a bottom layer 24. The top layer 22 is formed at least in part from the same material as footbed 20 of the sandal. In a preferred embodiment, the footbed 20 and top layer 22 are formed from yoga mat foam. The optional mat bottom layer may comprise the same material as the outsole 18 or may be a different material. One or more footwear upper portions 26a-g are attached to the mat. The upper portions maybe a sandal strap as shown or may be all or a forefoot portion of another type of footwear upper. Preferably, the upper portions 26a-g are the same style as the footwear marketed in association with the mat. In the FIGS. 1-2 embodiment, the upper portions 26a-g represent a size range, for example, women's sizes 5-11. Alternatively, the upper portions may include two or more color ways, or two or more footwear styles. Although seven upper portions are shown, any number could be used. The footbed outline 28a-g shown preferable is merely a painted or embossed outline of a footbed in a continuous mat top layer 22. Alternatively, the top layer 22 may be a composite comprised of footbed foam inserts 28a-g set into or on a layer of different material.

In a preferred embodiment, the mat 10 is equipped with a sound generation device 30, whereby a sound is generated when a person steps on the mat. Preferably, the sound is a “happy sound.” Happy sounds may include spoken sounds, such as “ooh,” or “ahh”; words, such as “wow” or “awesome”; slogans and short phases, such as “Smile . . . Pass It On™”; natural sounds, such as waves or bird calls; sound effects, such as a wind chime; or combinations thereof. In one embodiment multiple different happy sounds are randomly generated each time a person steps on the mat.

The sound generation device includes one or more sensors for sensing a person's foot on the mat. The sound generation device can be located in or on the mat, coupled to the mat, or located remotely and wirelessly connected to the mat. The sound generation device may be constructed in any matter, currently existing or later developed. FIG. 4 illustrates one embodiment of a sound generating device 30. It comprises one or more sensors 32a-g, such as pressure sensitive switches for example. In this embodiment, there are multiple sensors 32a-g, each associated with a respective one of the upper portions 26a-g and/or footbed outlines 28a-g. Device 30 further includes a CPU 34 or other programmable controller, a database 36 for storing happy sounds, a battery 38 and an audio output device 40, such as a speaker. In this embodiment, a sensor is associated with each upper or footbed. Different sounds optionally could be generated for the respective upper portions.

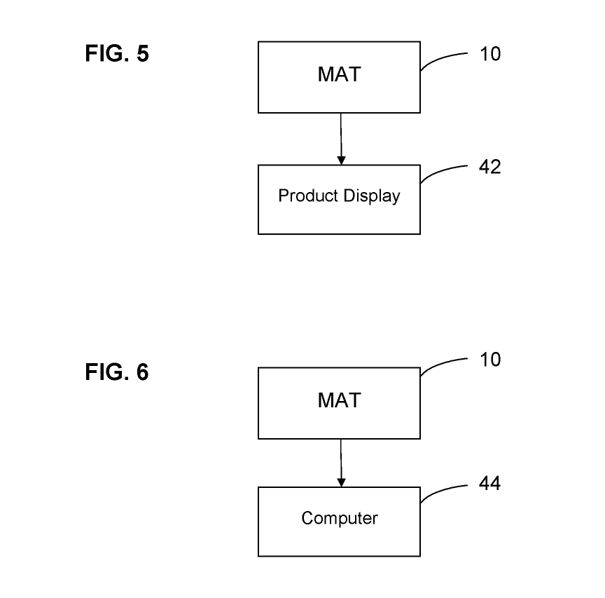

In a marketing system embodiment, mat 10 is used in association with a point of purchase display 42 as schematically illustrated in FIG. 5. Preferably the mat includes multiple size upper portions 26. Thereby, a person can use mat 10 to self determine the appropriate size, and then select the desired style/color/sized footwear for purchase without the assistance of a clerk.

FIG. 6 schematically illustrates another marketing system embodiment wherein mat 10 is used in association with a computer 44, such as a tablet computer. The mat 10 and computer 44 can optionally be housed in a kiosk within a store or mall. Preferably the mat 10 is connected, either hardwired or wirelessly, to the computer. The computer 44 is programmed to output both visual and audio signals in response to a person stepping on the mat. The audio output is preferably happy sounds as discussed above. The visual output from the computer's display may include product information, store promotions, advertising, still photographs, slide presentation and/or video. For example, beach or surf video could be presented as a part of the visual output. Further, the computer 44 is preferably configured to permit the consumer to input a consumer-to-consumer review message, such as, “gotta love these yoga mat sandals,” for other consumers at the same kiosk or globally through Facebook, Twitter, Pintrist or other social media.

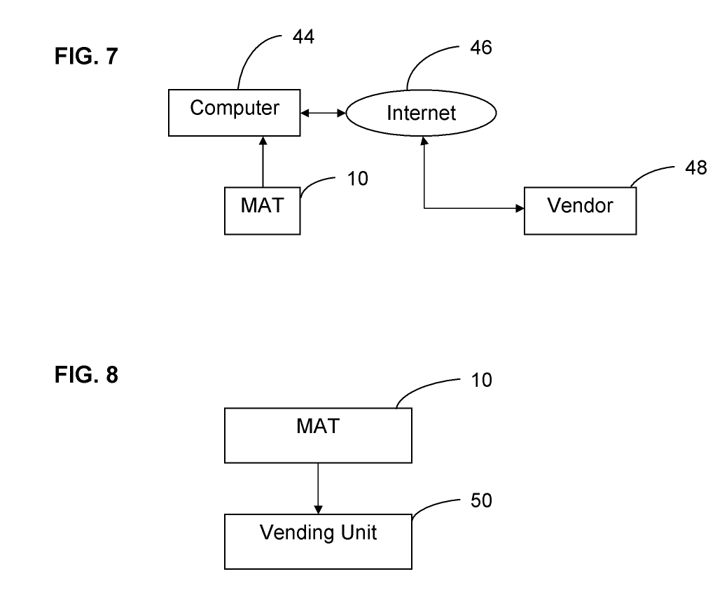

Optionally or in addition, the computer 44 can be connected via the internet is 46 to the website of the footwear brand owner or other vendor 48 as shown schematically in FIG. 7. Thereby, the consumer can order footwear for delivery, for example, next day courier delivery.

FIG. 8 illustrates yet another embodiment of the marketing system of the invention. In the FIG. 8 embodiment, mat 10 is used in association with a vending machine 50. This embodiment can find particular application in airports, resorts and beaches. Similar to the FIG. 5 embodiment, a person can use mat 10 to self determine the appropriate size, and then select the desired style/color/sized footwear for purchase without the assistance of a clerk. The size can be input directly to the vending machine from the position of the consumer's foot in a selected one of the upper portions. Alternatively, the consumer can manually select the style, size and color of the footwear. After selection, the vending machine displays the amount owed, which can be paid in cash or by credit card. Following payment the selected footwear is dispensed.

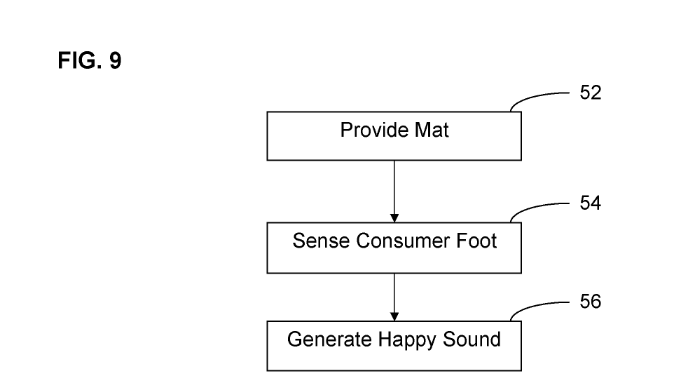

FIG. 9 illustrates a footwear marketing embodiment of the invention that comprises providing a mat 52, the mat having one or more layers, at least a portion of a top layer of the mat comprising of the same material as a top layer of the footwear sole; sensing 54 a consumer's foot on the mat, and generating a happy sound 56 in response to a consumer's foot on the mat. The presence of the mat on a floor in a store or other location invites potential consumers to experience the footwear. Because the mat is made from the same material as the footbed of the footwear, preferably yoga mat foam, the potential consumer experiences the feel of the cushy yoga mat footbed. The happy sound enhances the experience, expressing aurally what the person is feeling—“ooh, ahh.” An is enhanced buying experience is thereby provided. Further, if the mat includes a size range of upper portions as shown in the FIGS. 1-2 embodiment, the potential consumer can easily determine his/her size. The consumer can then select a desired pair of footwear for purchase on a self-service basis.

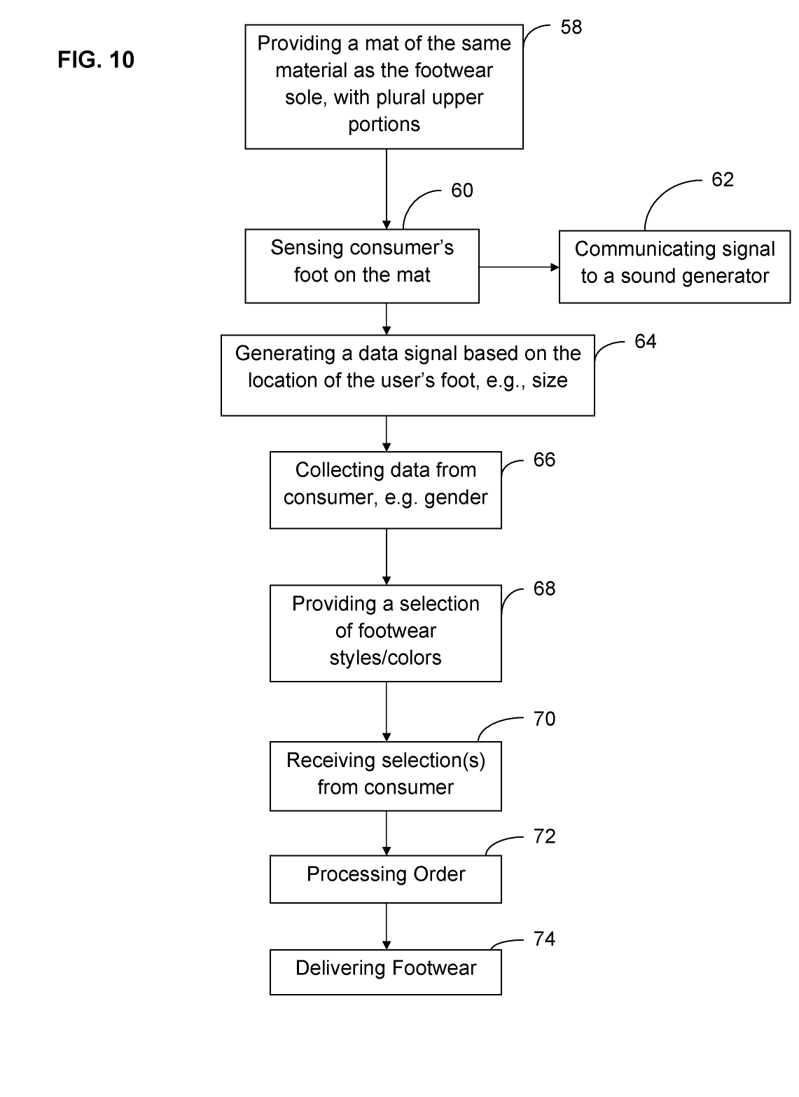

FIG. 10 illustrates another footwear marketing embodiment of the invention. The method comprises providing a mat 58 of the same material as the footwear sole, at least a portion of an upper of a plurality of units of the footwear attached to the mat, and at least one sensor for sensing the location of a consumer's foot on the mat. The sensor is connected to at least one of a sound generator, a computer or a vending machine In operation, a consumer's foot is sensed 60 on the mat, and in response a signal is generated and communicated 62 to the sound generator (or a vending machine or computer configured with a sound generator). Preferably the sound generator outputs a happy sound. In addition, the signal generated 64 from the mat can include data on the size (or in other embodiments color or style) of one of the plural footwear units based on the location of the consumer's foot on the mat. In the computer or vending machine embodiments, the computer or vending machine can be configured to receive additional data 66 from the consumer, such as gender, provide data 68 such as a selection of styles or colors of the footwear, receive additional selections from the consumer 70, accept payment from the consumer and process the order 72, and vend or otherwise deliver 74 a pair of footwear.

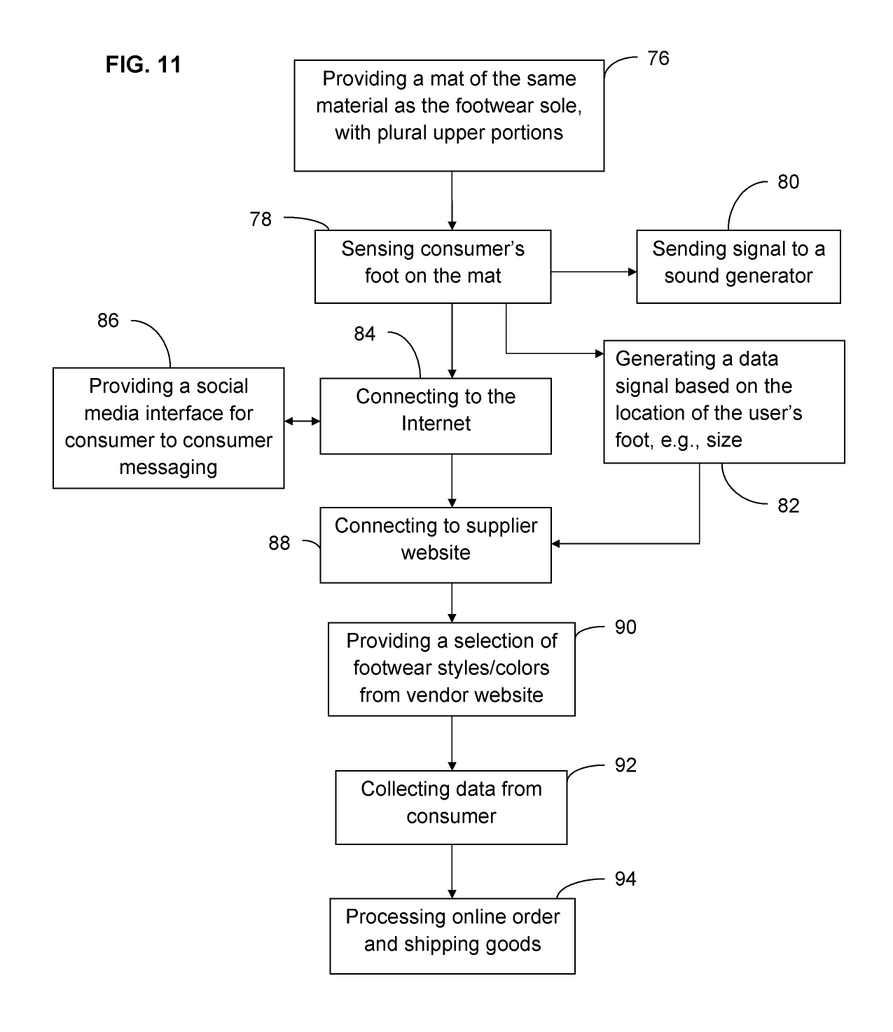

FIG. 11 illustrates yet another footwear marketing embodiment of the invention. The method comprises providing a mat 76 of the same material as the footwear sole, at least a portion of an upper of a plurality of units of the footwear attached to the mat, and at least one sensor for sensing the location of a consumer's foot on the mat. The sensor is connected to at least one of a sound generator, a computer or a vending machine In operation, a consumer's foot is sensed 78 on the mat, and in response a signal is generated and communicated 80 to the sound generator (computer configured with a sound generator). Preferably the sound generator outputs a happy sound. In addition, the signal generated 82 from the mat can include data on the size (or in other embodiments color or style) of one of the plural footwear units based on the location of the consumer's foot on the mat. The presence of the consumer on the mat can also activate a computer that is configured for connection to the Internet 84. Optionally, the computer can be configured for accepting and storing consumer entered data which is accessible to other consumers 86. This facilitates consumer to consumer (C2C) communication either at the particular location or via social media. Further, the method can optionally include a step of connecting 88 the computer to an online store for the footwear products. The online store provides 90 a selection of footwear styles and colors, collects data 92 from the customer, such as size, style and color, and processes 94 an online order. The footwear can be delivered at the site, or optionally can be delivered to the consumer by courier.

While preferred embodiments of the disclosure have been herein illustrated and described, it is to be appreciated that certain changes, rearrangements and modifications may be made therein without departing from the scope of the disclosure as defined by the appended claims.

What is claimed is:

1. An apparatus for selling footwear, the footwear having a sole comprised of one or more sole layers and an upper, comprising
a mat having one or more layers, at least a portion of the top layer of the mat comprising the same material as the top layer of the footwear sole,
at least a portion of an upper of at least one unit of the footwear attached to said mat over the said portion of the top layer of the mat comprising the same material as the top layer of the footwear sole,
at least one sensor coupled to the mat and configured to sense a consumer's foot on the mat, and
an audio or visual output device operatively connected to the sensor and configured to output an audio or visual signal in response to a consumer's foot on the mat.

2. A footwear selling apparatus as in claim 1 comprising a plurality of said footwear upper portions attached to said mat over the said portion of the top layer of the mat comprising the same material as the top layer of the footwear sole.

3. A footwear selling apparatus as in claim 2 wherein said plurality of upper portions include a plurality of sizes.

4. A footwear selling apparatus as in claim 2 wherein said plurality of upper portions include a plurality of color ways.

5. A footwear selling apparatus as in claim 2 wherein said plurality of upper portions include a plurality of footwear styles.

6. A footwear selling apparatus as in claim 1, wherein the at least one unit of footwear is a sandal and the upper portion is a sandal strap.

7. A footwear selling apparatus as in claim 1, wherein the portion of the top layer of said mat comprises yoga mat foam.

8. A footwear selling apparatus as in claim 1, wherein the portion of the top layer of said mat comprises PVC foam.

9. A footwear selling apparatus as in claim 1, wherein the portion of the top layer of said mat comprises closed cell rubber foam.

10. A footwear selling apparatus as in claim 1, wherein the portion of the top layer of said mat comprises a multilayer foam yoga mat.

11. A footwear selling apparatus as in claim 1, wherein the apparatus comprises plural footwear upper portions and plural sensors, at least one sensor configured to sense a consumer foot in each of the footwear upper portions.

12. A footwear selling apparatus as in claim 1, wherein said sensor is pressure actuated.

13. A footwear selling apparatus as in claim 1, audio or visual output device outputs one or more prerecorded happy sounds.

14. A footwear selling apparatus as in claim 13, wherein said audio or visual output device includes a random generator for outputting multiple randomly generated happy sounds.

15. A footwear selling apparatus as in claim 1, wherein said audio or visual output device output device includes an amplifier and battery mounted in or on the mat.

16. A footwear selling apparatus as in claim 1, further comprises an input device configured to permit a consumer to input a consumer to consumer message.

17. A footwear selling apparatus as in claim 1, further comprising a computer, which includes said audio or visual output device.

18. A footwear selling apparatus as in claim 17, further comprising an internet connection for linking the mat to a website.

19. A footwear selling apparatus as in claim 1, further comprising a point of purchase display linked to said mat.

20. A footwear selling apparatus as in claim 1, further comprising a footwear vending machine linked to said mat.

21. An apparatus for selling footwear, the footwear having a sole and an upper, comprising
a mat comprising the same material as the footwear sole,
a plurality of footwear upper portions attached to the mat,
at least one sensor coupled to the mat and configured to sense a consumer's foot on the mat, and
an audio output device mounted in the mat and operatively connected to the sensor to output an audio sound in response to a consumer's foot on the mat.

22. A method of selling footwear having a sole and an upper, comprising
providing a mat having one or more layers, at least a portion of a top layer of the mat comprising the same material as a top layer of the footwear sole,
sensing a consumer's foot on the mat, and
generating a happy sound in response to a consumer's foot on the mat.

23. A method of selling footwear as in claim 22 wherein one or more footwear upper portions are attached to the mat.

24. A method of selling footwear having a sole and an upper, comprising
providing a mat comprised of the same material as the footwear sole, at least a portion of an upper of a plurality of units of the footwear attached to the mat, and at least one sensor for sensing the location of a consumer's foot on the mat,
connecting the sensor to at least one of a sound generator, a vending machine and a computer,
sensing a consumer's foot on the mat,
generating a signal in response to a consumer's foot on the mat, and
communicating the signal to the sound generator, vending machine or computer.

25. A method of selling footwear as in claim 24, wherein the signal is an audio happy sound.

26. A method of selling footwear as in claim 24, wherein the signal includes data on the size, color or size of one of said plural footwear units based on the location of the consumer's foot on the mat.

27. A method of selling footwear as in claim 26, wherein a vending machine is connected to the sensor, and further comprising
receiving additional data from the consumer on the style, size or color of the footwear,
accepting payment from the consumer, and
vending a pair of footwear.

28. A method of selling footwear as in claim 26, wherein a computer is connected to the sensor, and further comprising the step of outputting data via the computer to the consumer based on the position of the consumer's foot on the mat.

29. A method of selling footwear as in claim 28, further comprising the step of accepting and storing consumer to consumer messages entered via the computer which messages are accessible to other consumers.

30. A method of selling footwear as in claim 28, further comprising the step of connecting the computer to an online store for the footwear products.
